(19) United States
(12) Patent Application Publication
(10) Pub. No.: US 2002/0035534 A1
(43) Pub. Date: Mar. 21, 2002

(54) Method and apparatus for auctioning securities

(76) Inventors: Walter D. Buist, Hasbrouck Heights, NJ (US); Mark F. Loehr, Larchmont, NY (US)

Correspondence Address: PENNIE AND EDMONDS, 1155 AVENUE OF THE AMERICAS, NEW YORK, NY, 100362711

(21) Appl. No.: 09/845,224

(22) Filed: Apr. 30, 2001

Related U.S. Application Data
(60) Provisional application No. 60/202,379, filed on May 4, 2000.

(51) Int. Cl. G06F 17/60

(52) U.S. Cl. 705/37; 705/36

(57) ABSTRACT

The present invention is a system and method for conducting an on-line auction of securities. A preferred method of auctioning a security comprises the steps of: transmitting to a plurality of potential bidders information identifying the security, a price range having a maximum price and a minimum price, and a time for the auction; receiving from each bidder an offer price for a number of units of the security; transmitting to bidders information concerning the bids that are received; closing the auction either when offers are received for all units of the security at the maximum price or when a predetermined time has elapsed; and upon closing the auction, allocating units of the security so that all bids at a price in excess of the closing price are filled and all bids at the closing price or less are filled on a first-come, first-served basis.

### CROSS-REFERENCE TO RELATED APPLICATIONS

This application claims priority to U.S. Provisional Application No. 60/202,379, filed May 4, 2000, the contents of which are incorporated herein in their entirety by reference.

### BACKGROUND OF THE INVENTION

In the United States, the trading of securities is closely regulated under the Securities Exchange Act of 1934, 15 U.S.C. §§ 78a-78mm. The term “security” is defined in 15 U.S.C. § 78c(a)(10) as “any note, stock, treasury stock, bond, debenture, certificate of interest or participation in any profit-sharing agreement or in any oil, gas, or other mineral royalty or lease, any collateral-trust certificate, preorganization certificate or subscription, transferable share, investment contract, voting-trust certificate, certificate of deposit, for a security, any put, call, straddle, option, or privilege on any security, certificate of deposit, or group or index of securities (including any interest therein or based on the value thereof), or any put, call, straddle, option, or privilege entered into on a national securities exchange relating to foreign currency, or in general, any instrument commonly known as a ‘security’; or any certificate of interest or participation in, temporary or interim certificate for, or warrant or right to subscribe to or purchase, any of the foregoing . . . but shall not include currency or any note draft, bill of exchange, or banker's acceptance which has a maturity at the time of issuance of not exceeding nine months, exclusive of days of grace, or any renewal thereof the maturity of which is likewise limited.”

The present invention is applicable to the distribution of any type of security as broadly defined under the U.S. Securities Exchange Act of 1934 or under the laws of other nations.

At present, it is contemplated that the invention will be especially useful in the distribution of securities in so-called secondary or follow-on offerings and the invention will be described in that context. However, the invention may also be practiced to distribute securities at other times as well.

The allocation of securities at an initial public offering or a secondary offering is a source of concern to many individual investors. In cases where these offerings are oversubscribed, many individual investors believe that the securities are distributed unfairly —either on the basis of prior relationships, the size of the distributee's account with the underwriter, the amount of the distributee's trading activity with the underwriter, or some other criterion that the individual investor has little opportunity to influence. Oftentimes, the most popular offerings seem to be allocated almost exclusively to large institutional investors presumably on the basis of the volume of business they do with the underwriter.

While some success has been achieved in recent months in making more of these offerings available to individual investors, much remains to be done.

A second problem relates to the availability of market information, particularly, knowledge as to the price and volume of buy and sell orders at any time. While this information is available to market makers, it generally is not available to the public.

The present invention is intended to address this problem as well in the circumstances of auctioning securities.

### SUMMARY OF INVENTION

The present invention is a system and method for conducting an on-line auction of securities.

A preferred method of auctioning a security comprises the steps of:

transmitting to a plurality of potential bidders information identifying the security, a price range having a maximum price and a minimum price, and a time for the auction;

receiving from each bidder an offer price for a number of units of the security, transmitting to bidders information concerning the bids that are received, closing the auction either when offers are received for all units of the security at the maximum price or when a predetermined time has elapsed, and upon closing the auction, allocating units of the security so that all bids at a price in excess of the closing price are filled and all bids at the closing price or less are filled on a first-come, first-served basis.

### BRIEF DESCRIPTION OF DRAWINGS

These and other objects, features and advantages of the invention will be more readily apparent from the following detailed description of the invention in which:

FIG. 1 is a block diagram illustrating a preferred embodiment of the invention;

FIG. 2 is a flowchart illustrating a preferred method of the invention;

FIGS. 3 through 14 are illustrations of the user interface depicting various elements of the invention.

FIGS. 15A & 15B depict a display of illustrative auction rules and procedures.

### DETAILED DESCRIPTION OF PREFERRED EMBODIMENTS

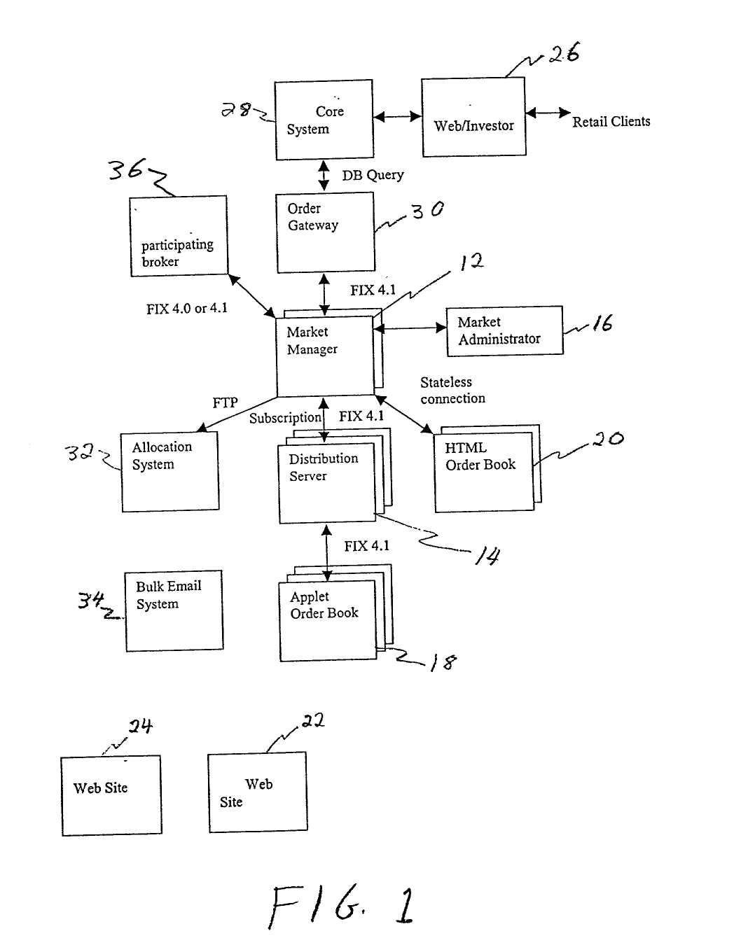

As shown in FIG. 1, a preferred system 10 for practicing the invention comprises a market manager 12, a distribution server 14, a market administrator 16, an applet order book 18, an HTML order book 20, a first web site 22, a second web site 24, an order entry interface 26, an order management system 28, an order gateway 30, an allocation system 32, a bulk e-mail system 34, and an institutional investor interface 36.

Market manager 12 is the order engine component of the auction system. It processes orders and maintains the order book. This is written in Java and will run on IBM's AIX operating system.

The market manager supports a FIX 4.0 and FIX 4.1 based interface to receive orders. Any client that conforms to this FIX based protocol can connect to the market manager and contribute orders.

The market manager supports a FIX 4.1 subscription-based interface to transmit orders. Any client that conforms to this FIX based protocol can connect to the market manager and receive orders. Orders that are received are logged and sent to all subscribed market manager clients in real-time. In the current system, the distribution server 14 is a subscription-based client of the market manager.

The market manager also supports a FIX 4.1 based stateless API. Any client who conforms to this API can connect to the market manager, make a specific call, receive the data and then disconnect.

At this time, two instances of the market manager will run, one on each of two RS/2000 SP2 nodes. One is a hot standby to the other.

Distribution server 14 receives all valid orders from the market manager and maintains order books for distribution to all clients. Extensive description of the distribution server is found in U.S. patent application No. 09/292,553, filed Apr. 15, 1999, for “A System and Method for Conducting Securities Transactions Over a Computer Network,” the contents of which are incorporated herein by reference in their entirety.

The distribution server supports persistent connections for real-time unicast messaging to all connected clients. It can support any client that conforms to its FIX 4.1-based messaging interface. Any client that conforms to this FIX based protocol can connect to the distribution server and subscribe to an offering. In the current system, the Java applet order book 18 is a client of the distribution server.

At this time, three instances of the distribution servers will run, one on each of three RS/2000 SP2 nodes. These three servers run in parallel in a load-balanced cluster.

Market administrator 16 is a web based auction administration tool for the market manager. The functions offered by the market administrator include offering management (deals, issuers, ranges, etc.), order entry (for retail block orders), and allocation management (viewing allocation scenarios, finalizing the allocation, etc.).

The market administrator is written in Java servlets and can run on either AIX or Windows NT.

At this time, two instances of the market administrator will run, one on each of two RS/2000 SP2 nodes. These two servers will run in a load-balanced cluster.

Applet order book 18 is the user interface for displaying and operating the auction order book. This interface displays, for any given auction, the current book showing the current order summary (at each price) across the large and small order books.

The applet is written in Java code and currently run on virtually all HTML browsers that support a Java virtual machine.

HTML order book 20 is an HTML version of the applet described above. This interface displays, for any given auction, the current book showing the current order summary (at each price) across the large and small order books. The HTML order book is a stateless client of the market manager.

The HTML order book is a Java servlet coupled with a jsp based script. This can be hosted on any application server that supports these services.

At this time, two instances of the HTML order book will run, one on each of two RS/2000 SP2 nodes. These two servers will run in a load-balanced cluster.

First web site 22 is the auction site that is used by individual investors (retail clients) to review rules and procedures and place orders.

The first web site is written in html/jsp based script. This can be hosted on any application server that supports these services.

At this time, two instances of the first web site will run, one on each of two RS/2000 SP2 nodes. These two servers will run in a load-balanced cluster.

The second web site 24 represents the product on the Internet. This site contains promotional information, issuer product information, rules of the auction, etc.

The second web site is written in html/jsp based script. This can be hosted on any application server that supports these services.

At this time, two instances of the second web site will run, one on each of two RS/2000 SP2 nodes. These two servers will run in a load-balanced cluster.

Order entry interface 26 provides order entry pages and open order screens for auction orders. This system is used currently by WitSoundView's retail clients to monitor their accounts, place trades, and conditional offers.

The interface is composed of web servers, cgi scripts (written in RPG) and HTML templates with data replacement variables.

Order management system 28 is the core order management system. It is the core order management platform used for managing secondary market trading and offerings.

Order gateway 30 takes orders from the order management system for new, changed, or canceled auction orders. These orders will first be checked against a file of excluded accounts. These orders will be translated to the FIX protocol and sent to the market manager. Orders placed by excluded accounts will not be sent to the market manager.

It is written in Java code and currently runs on IBM's AIX system.

At this time, two instances of the order gateway will run, one on each of two RS/2000 SP2 nodes. One is a hot backup to the other.

Allocation system 32 performs the allocation for IPOs and secondaries. There is also a customer service interface, for inquiries regarding allocations in previous deals. The allocation system also interacts with bulk e-mail system 34 for sending IPO alerts, allocation notices, etc.

The allocation system 32 is a Java servlet coupled with a jsp based script. This can be hosted on any application server that supports these services.

Bulk e-mail system 34 is used for all bulk outbound e-mailings. The bulk e-mail server is used to send all client notifications for an auction.

The bulk email system is a Java servlet coupled with a jsp based script. This can be hosted on any application server that supports these services.

Institutional interface 36 provides order entry pages and open order screens for auction orders from institutional investors.

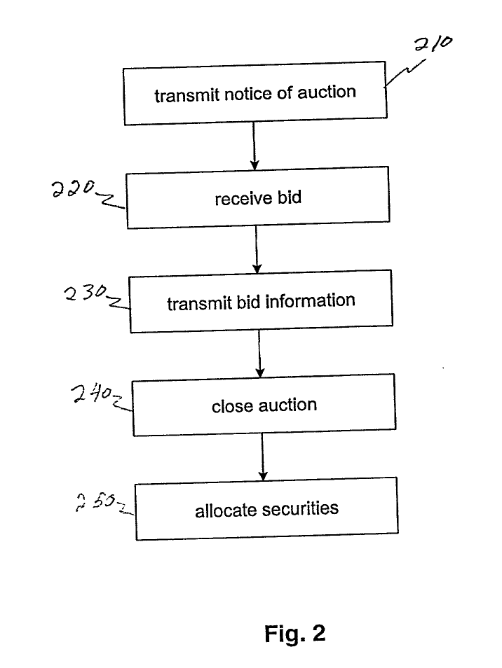

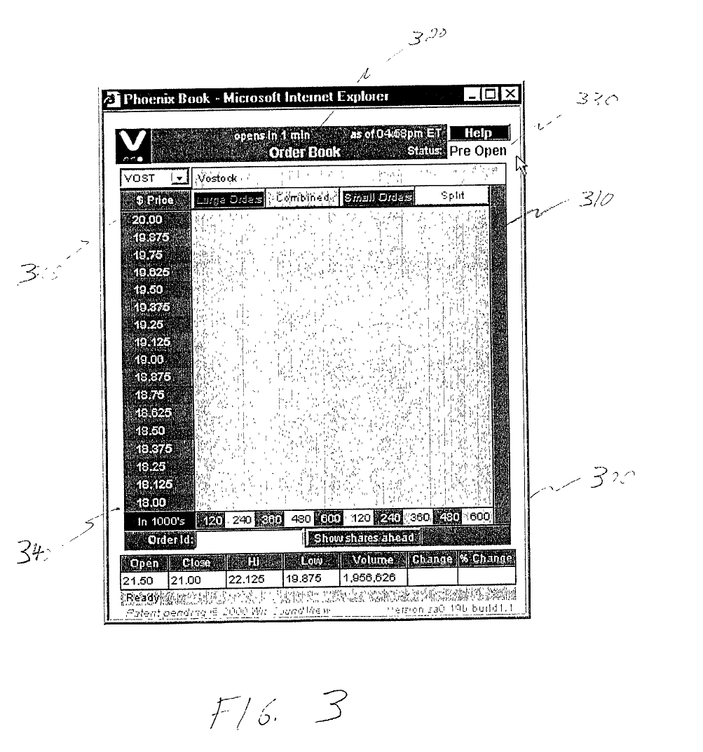

FIG. 2 illustrates the steps performed by a preferred embodiment of the invention. In the case of a secondary offering, the offering will typically take place after the close of the market and at a maximum price that is less than the market close. Potential participants in the auction will be notified at step 210 by transmitting to them a notice of the auction via email using the bulk e-mail system 34. The notice preferably comprises information identifying a security to be auctioned, the maximum and minimum prices, and a time for the auction. Additional information about the security offered may be made available through the SEC's EDGAR system, the underwriter's web site or the system's second web site 24. Such information may include prospectuses, annual reports of the security issuer, SEC filings, promotional literature and the like to the extent permitted by applicable laws.

When the specified auction time is reached, a bid is received at step 220 from each bidder. Individual investors submit their bid through their brokers via order entry interfaces 26. Institutional investors submit their bids through institutional interfaces 36.

Each bid comprises an offer price for a number of units of the security being auctioned. Each bid is a legally binding firm offer to buy the quantity of the security at the price specified. However, the bid may be canceled at any time before the auction closes; and a bidder may make as many bids and cancel as many bids as he likes before the auction closes.

For each bid that is submitted, the system assigns a tracking number that enables the system to match the bidder with the bid and a time stamp that enables the system to determine when the bid was made. While the sources of the bids are known to the system, the identity of the bidders is not provided to other bidders and the bidders therefore remain anonymous to each other.

Bid information is continuously made available at step 230 to all participants in the auction via order books 18 and 20. The bid information comprises information indicating the number of units of the security that are bid for at each offer price. Steps 220 and 230 are repeated until the auction is closed, at step 240.

The auction closes either when offers are received for all units of a security at a maximum price or when a predetermined time has elapsed. Typically, the predetermined time for the auction is 90 minutes. At the close of the auction, the closing price is determined by the highest price at which all the shares can be sold. Typically, there will be some oversubscription of shares at the closing price.

Oversubscription is dealt with at step 250 by allocating the shares. This is done in two steps. First, all bids in excess of the closing price are filled. Then all bids at the closing price are filled on a first-come, first-served basis. Thus, the system rewards the higher bidders first and, after them, the earlier bidders. This should encourage bidders to make realistic bids early and should discourage bidders from canceling bids since they would lose the time advantage of the canceled earlier bid.

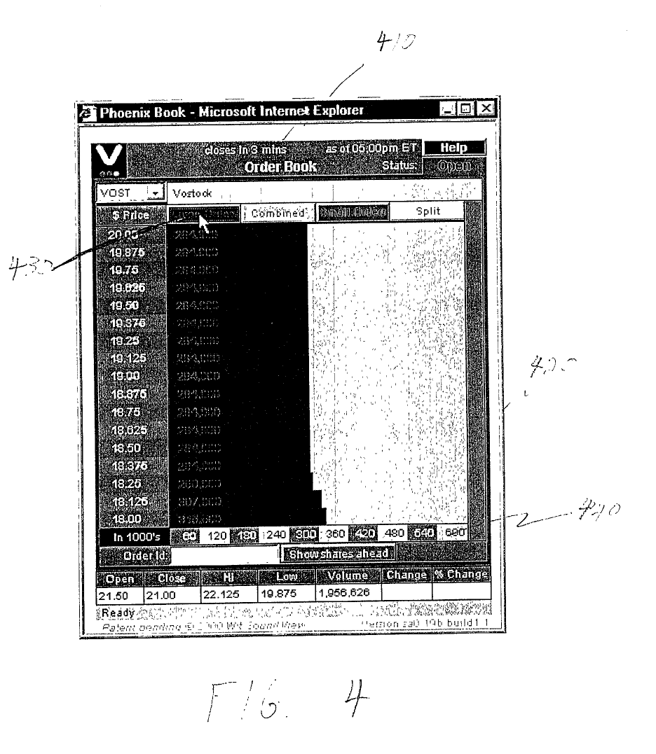

FIGS. 3-14 depict various display screens used in the auction process. Advantageously, a single screen permits the display of several order books: a large order order book, a small order order book, a combined order book that combines the large and small orders, and a split screen order book that provides for simultaneous display of the large order and small order order books. Typically, in the case of stock, the order size that differentiates large and small orders is 1000 shares of stock, but other sizes can be used depending on the offering.

The differentiation between large and small orders makes it possible to treat these orders differently. For example, at the election of the issuer of the security, a certain percentage of the securities offered (perhaps 25%) may be reserved for small orders to ensure greater distribution of the securities. Use of such a reservation would also protect those entering the small orders (presumably individual investors) from being driven out of the auction by a very large last minute offer from an institutional investor.

FIG. 3 depicts a pre-auction display. An order book 300 is displayed with a yellow border 310, to notify a user that an auction is about to begin. A notification 320 shows how much time remains before the auction begins. A “Pre Open” notice 330 is also displayed. The price 335 indicates the maximum bid that will accepted, and the price 340 indicates the minimum acceptable bid.

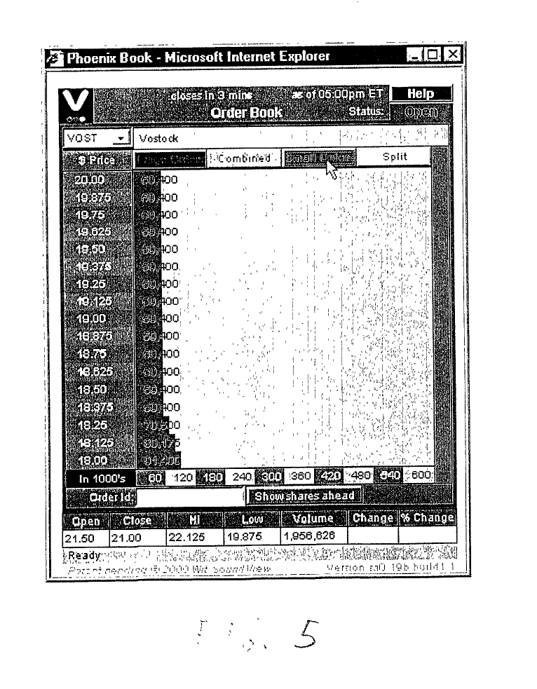

FIG. 4 depicts an order book display for an auction that is near its conclusion. A notification 410 shows the time left in the auction. The order book 420 displays information for large orders (orders of 1000 or more shares) only. A user selects the large orders display by clicking the button 430. The large orders are displayed in multiples of 1000 shares, keyed to the scale 440. Thus a user can instantly see what prices have been offered for a given number of shares. For example, the order book in FIG. 4 indicates that bids have been received for 284,000 shares at $20/share or better, and that bids for 307,000 shares have been received at $18.125/share or better.

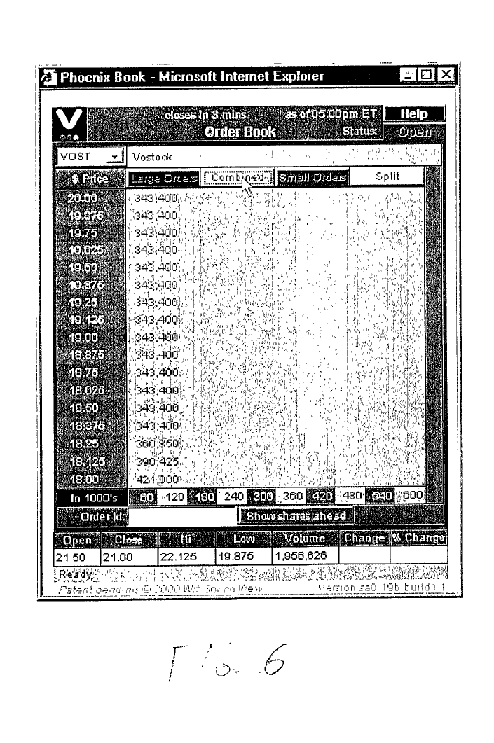

FIG. 5 depicts an order book display that shows small orders only. A user selects this view by clicking on the “Small Orders” button, indicated by the cursor.

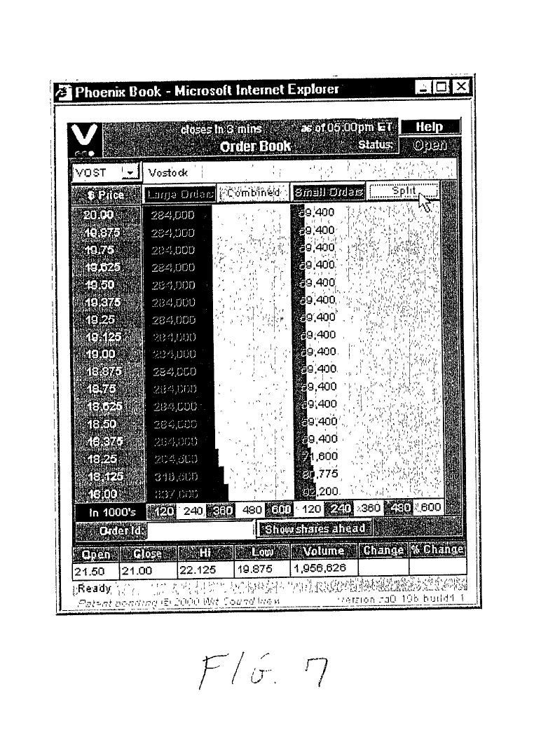

FIG. 6 depicts an order book display that shows large orders and small orders (orders of less than 1000 shares) aggregated. A user selects this view by clicking on the “Combined” button, indicated by the cursor.

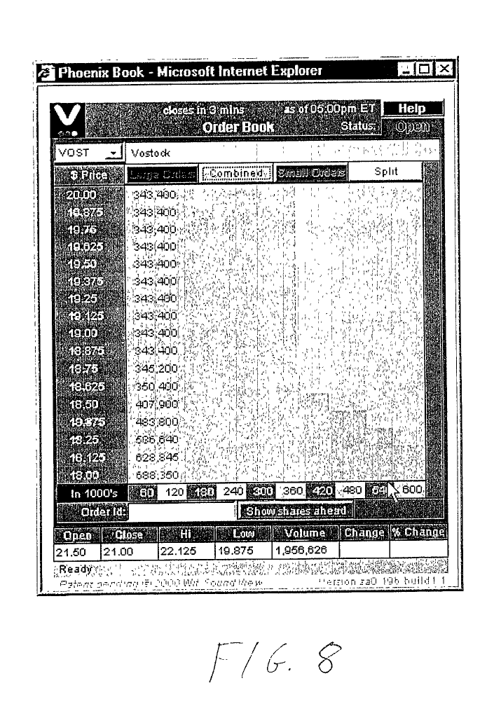

FIG. 7 depicts an order book display that shows a split screen view of orders. One side of the split screen shows large orders only, and the other side of the split screen displays small orders only. A user selects this view by clicking on the “Split” button, indicated by the cursor.

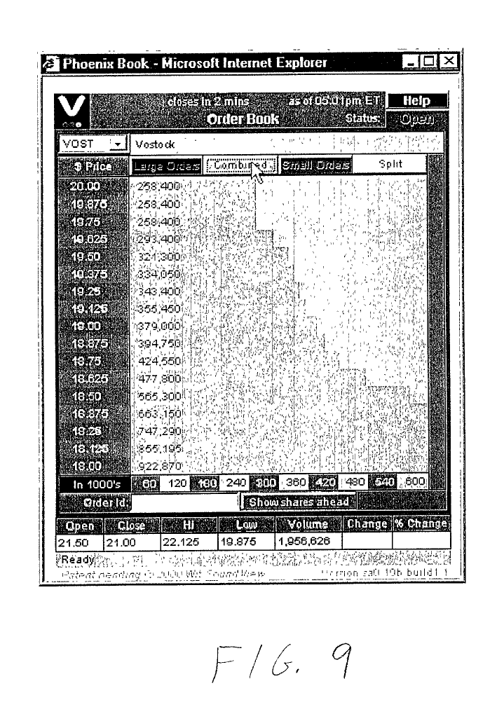

The order books will fill up during the course of an auction as shown in FIGS. 8-13.

FIG. 8 depicts an order book display for an auction with 3 minutes left. For the auction illustrated, the total number of shares available is 600,000. Thus, in FIG. 8, the selling price for the shares is $18.125—the highest price at which all of the shares in the auction can be sold.

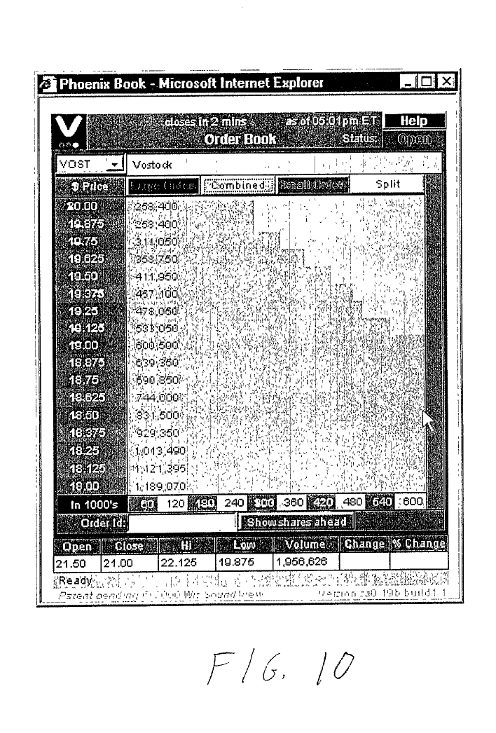

FIG. 9 depicts an order book display for the same auction to which FIG. 8 is directed, but at a later point in time (as the display indicates, only 2 minutes are left). However, in FIG. 9, the price for the shares has been bid upward. Thus, in FIG. 9 the selling price for the shares is $18.375.

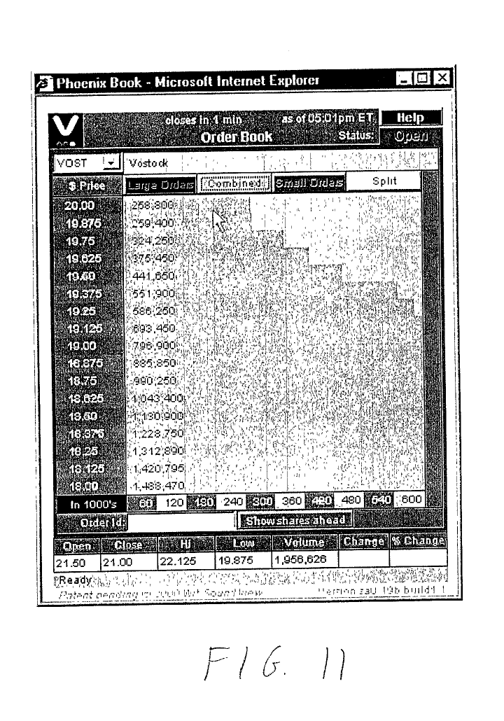

FIG. 10 depicts an order book display for the same auction as in FIGS. 8 and 9, but at a slightly later point in time. In FIG. 10, the selling price has been bid even further upward, and is $19.

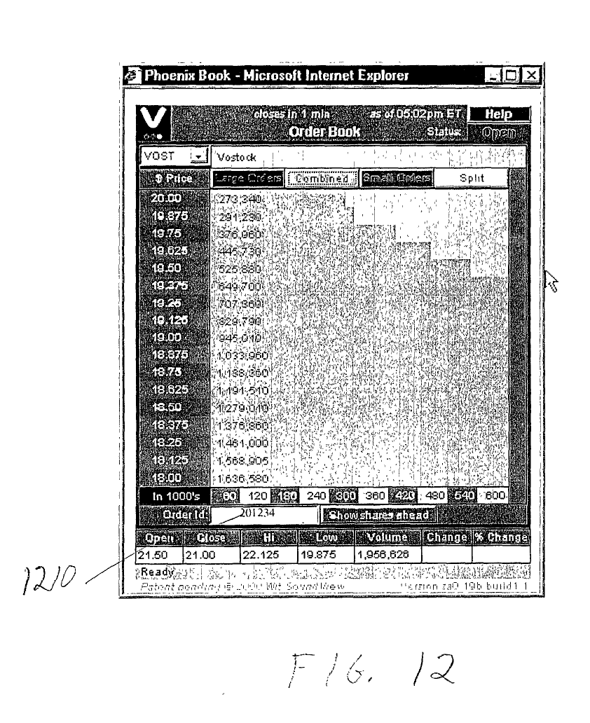

FIG. 11 depicts an order book display for the same auction as in FIGS. 8-10, but at an even later point in time (only 1 minute is left). In FIG. 11, the selling price has been bid up to $19.125 (the highest price for which there are bids for at least 600,000 shares).

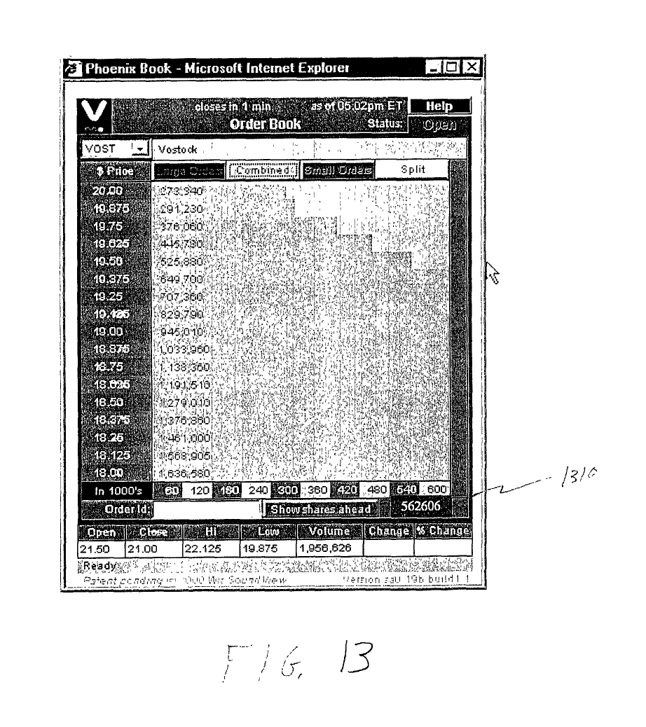

FIG. 12 depicts on order book display for the same auction as in FIGS. 8-11, but at a slightly later point in time. In FIG. 12, the selling price has been bid up to $19.375. An Order ID 1210, representing an order placed by a user, is shown in the order book display.

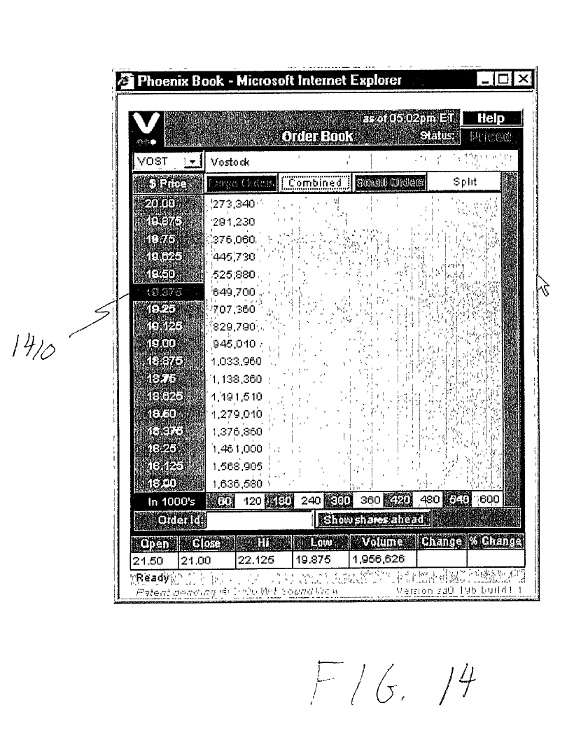

FIG. 13 depicts the same selling price display as FIG. 12, but the Order ID is no longer displayed. However, the number of shares ahead of the order corresponding to Order ID 1210 is displayed in the “Show shares ahead” display 1310. The number of shares ahead is the number of shares for which the bid price is higher than the bid price of the order having Order ID 1210 plus the number of shares at the same bid price as Order ID 1210 but earlier in time. Thus, the number of shares ahead and the time remaining in the auction will give the bidder an idea of the likelihood that his bid will be successful.

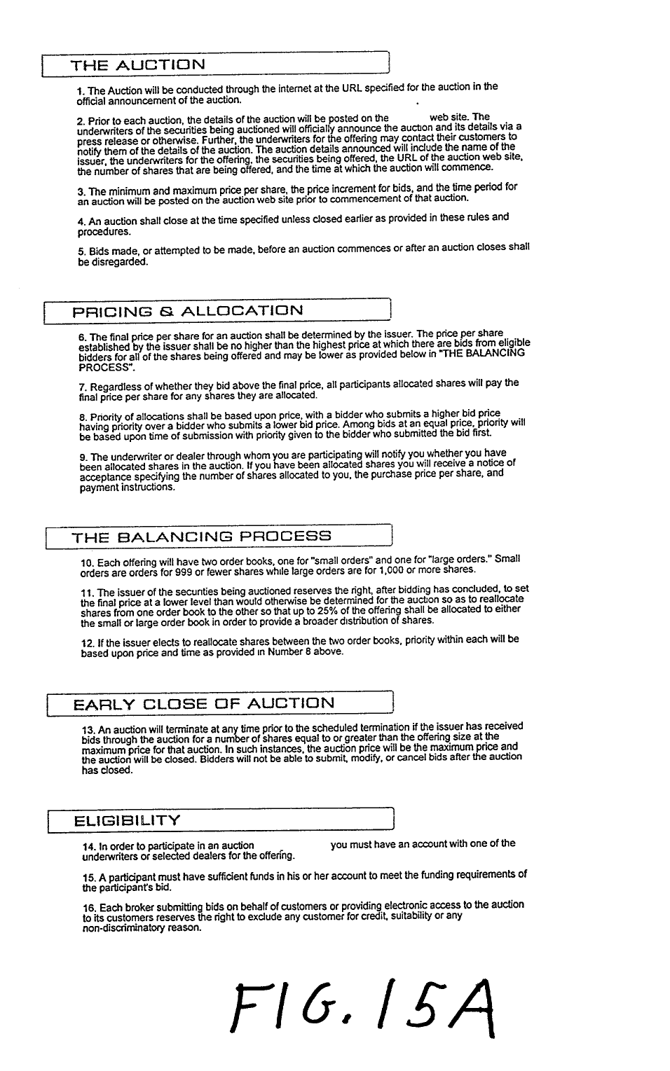

FIG. 14 depicts an order book display after an auction has closed. An indicator 1410 highlights the final selling price for the shares (in this example, $19.375).

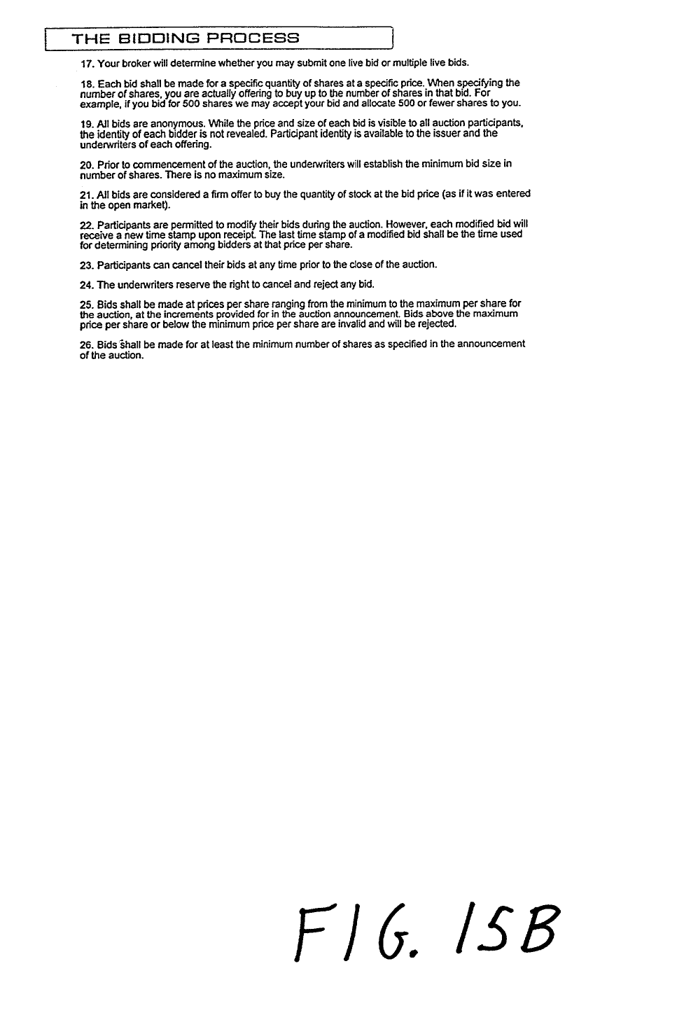

An exemplary display of illustrative auction rules and procedures is depicted in FIGS. 15A & 15B.

The foregoing system and method of auctioning securities provides many advantages to security issuers and to institutional and individual investors.

Among the benefits to a security issuer are:

(1) The auction allows the fastest speed to market, enabling the issuer to capitalize on short-term demand and significantly reduce market risk.

(2) The Internet closes the distance between the issuer and potential investors. The issuer is no longer limited to existing channels via the underwriters.

(3) The auction is flexible, enabling the issuer to be free from the timing constraints of the traditional roadshow process.

(4) Bookbuilding and price discovery are made visible to the issuer. A preferred embodiment allows an issuer to watch an order book as it builds and to track the demand at each price level.

(5) The auction rules and procedures encourage the submission of real and early bids, since price and time of bids are the primary drivers of share allocation.

(6) Both current and prospective shareholders have open access to investing in an issuer's company through the auction process.

(7) Issuers have the option (not an obligation) of allocating up to 25% of the shares offered to either the large or small order book. This helps to ensure a broader distribution of shares.

Among the advantages to an institutional investor are the following:

(1) Institutional investors can watch an order book as it builds and track the demand at each price level, and can view the order book from four different perspectives: large orders (orders of 1,000 shares or more), small orders, the combined order book, or a split screen detailing large and small orders side by side.

(2) All bids are anonymous.

(3) The price bid and time at bid placement are the primary drivers of share allocation. Allocations are no longer driven by prior relationships or dictated by being a “good customer.”

(4) Bookbuilding and price discovery are transferred to the issuer and the investors, and are no longer in the hands of the underwriters. Auction participants specify a price and quantity of shares that eventually determine the final price per share in the auction.

Among the benefits to an individual investor are:

(1) An individual investor can watch an order book as it builds and track the demand at each price level and can view the order book from four different perspectives: large orders (orders of 1,000 shares or more), small orders, the combined order book, or a split screen detailing large and small orders side by side.

(2) Price and timing—not the individual investor's asset base, not how much they trade, not prior relationships—are the primary drivers of a successful bid.

(3) The issuer can elect to reserve a percentage of the offering for small orders.

As will be apparent to those skilled in the art, numerous modifications may be made to the above described system and method that are within the spirit and scope of the invention and the appended claims.

What is claimed:

1. A method of conducting an on-line auction of a security comprising the steps of:
transmitting to a plurality of potential bidders information identifying the security, a price range having a maximum price and a minimum price, and a time for the auction;
receiving from each bidder an offer price for a number of units of the security, transmitting to bidders information concerning the bids that are received, said information indicating the number of units that are bid for at each offer price, closing the auction either when offers are received for all units of the security at the maximum price or when a predetermined time has elapsed, and upon closing the auction, allocating units of the security so that all bids at a price in excess of a closing price are filled and all bids at the closing price or less are filled on a first-come, first-served basis.

2. A computer system for conducting an on-line auction of a security comprising:
means for transmitting to a plurality of potential bidders information identifying the security, a price range having a maximum price and a minimum price, and a time for the auction;
means for receiving from each bidder an offer price for a number of units of the security, means for transmitting to bidders information concerning the bids that are received, means for closing the auction either when offers are received for all units of the security at the maximum price or when a predetermined time has elapsed, and means for allocating units of the security upon closing the auction, so that all bids at a price in excess of a closing price are filled and all bids at the closing price or less are filled on a first-come, first-served basis.

3. Computer software on a readable medium for conducting an on-line auction of a security by:
transmitting to a plurality of potential bidders information identifying the security, a price range having a maximum price and a minimum price, and a time for the auction;
receiving from each bidder an offer price for a number of units of the security, transmitting to bidders information concerning the bids that are received, closing the auction either when offers are received for all units of the security at the maximum price or when a predetermined time has elapsed, and upon closing the auction, allocating units of the security so that all bids at a price in excess of a closing price are filled and all bids at the closing price or less are filled on a first-come, first-served basis.
